(19) United States
(12) Patent Application Publication
(10) Pub. No.: US 2012/0120071 A1
(43) Pub. Date: May 17, 2012

(54) SHADING GRAPHICAL OBJECTS BASED ON FACE IMAGES

(75) Inventor: Ola Karl Thorn, Malmo (SE)

(73) Assignee: SONY ERICSSON MOBILE COMMUNICATIONS AB, Lund (SE)

(21) Appl. No.: 13/142,492

(22) PCT Filed: Jul. 16, 2010
(86) PCT No.: PCT/IB2010/053261

§ 371 Date: Jun. 28, 2011

(51) Int. Cl. G06T 17/00; G09G 5/00

(52) U.S. Cl. 345/420; 345/633

(57) ABSTRACT

A device may include a transceiver for communicating with another device, a memory to store images, and a processor. The processor may recognize, in each of a plurality of images, an image of a face, shade an image of a virtual object based on the images of the face, and store the shaded image in the memory.

### BACKGROUND

In gaming, user interface, or augmented reality (AR) technology, a device may generate images of three-dimensional, virtual objects in real time (e.g., two-dimensional or three-dimensional images). Generating the images may include applying various computer-graphics techniques, such as shading, texture mapping, bump mapping, etc.

### SUMMARY

According to one aspect, a method may include receiving, by a graphics device, a plurality of images from a camera. The method may also include recognizing, in each of the images, an image of a face, generating an image of a virtual object and shading the image of the virtual object based on the images of the face, and displaying the generated image of the virtual object on a first display screen.

Additionally, generating the image may include applying texture mapping or adding motion blur to the image.

Additionally, the images of the face may include shadings. Additionally, generating the image of the virtual object may include using the images of the face to determine directions and magnitudes of light rays that would have produced the shadings on the images of the face and using the determined directions and magnitudes of the light rays to create shadings on the image of the virtual object.

Additionally, using the images of the face may include generating a three-dimensional model of the face.

Additionally, generating the image of a virtual object may include providing non-photorealistic rendering of the virtual object.

Additionally, generating an image may include generating the image by at least one of a gaming application, an augmented reality (AR) device, or a graphical user interface.

Additionally, receiving the plurality of images may include receiving the plurality of images from a remote device that includes the camera.

Additionally, generating the image may include generating two different images of the virtual object for two different displays that are located in different places.

Additionally, displaying the generated image may include sending the generated image to a remote device to be displayed.

Additionally, generating the image may include generating separate images for right and left eyes.

According to another aspect, a device may include a transceiver for communicating with another device, a memory to store images, and a processor. The processor may recognize, in each of a plurality of images, an image of a face, shade an image of a virtual object based on the images of the face, and store the shaded image in the memory.

Additionally, the processor may be further configured to determine virtual light sources based on the images of the face.

Additionally, the processor may be further configured to obtain a three-dimensional model of the face.

Additionally, the device may include a tablet computer; a smart phone; a laptop computer; a personal digital assistant; or a personal computer.

Additionally, the transceiver may be configured to receive the plurality of images from a remote device or the processor may be configured to receive the plurality of images from a camera installed on the device.

Additionally, the device may further include a display screen. The processor may be configured to display the shaded image on the display screen or send the shaded image to a remote device to be displayed.

Additionally, the shaded image of the virtual object may include the image of the face.

According to yet another aspect, a computer-readable storage unit may include a program for causing one or more processors to receive a plurality of images from a camera, recognize, in each of the images, an image of a first object, determine a three-dimensional model of the first object and virtual light sources based on the recognized images of the first object, generate images of virtual objects and shade the images of the virtual objects based on the virtual light sources, and display the generated images of the virtual objects on one or more display screens.

Additionally, the program may include at least one of an augmented-reality program, a user interface program, or a video game.

Additionally, the computer readable storage unit of may further include instructions for applying texture mapping or motion blur to the generated images of the virtual objects.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIGS. 1A through 1C illustrate concepts described herein;

FIG. 2 shows an exemplary system in which concepts described herein may be implemented;

FIGS. 3A and 3B are front and rear views of the exemplary graphics device of FIG. 1A according to one implementation;

FIG. 4 is a block diagram of exemplary components of the graphics device of FIG. 1A;

FIG. 5 is a block diagram of exemplary functional components of the graphics device of FIG. 1A; and

FIG. 6 is a flow diagram of an exemplary process for shading virtual objects based on face images.

### DETAILED DESCRIPTION

The following detailed description refers to the accompanying drawings. The same reference numbers in different drawings may identify the same or similar elements. As used herein, the term “shading” may include, given a lighting condition, applying different colors and/or brightness to one or more surfaces. Shading may include generating shadows (e.g., an effect of obstructing light) or soft shadows (e.g., applying shadows of varying darkness, depending on light sources).

In one embodiment, a device may capture images of a face, and, by using the images, may determine/estimate a three-dimensional model of the face. Based on the model, the device may determine the directions of light rays (or equivalently, determine virtual light sources) that would generate the shades on the face images or the model. The device may then use the virtual light sources to render proper shadings on images of other objects (e.g., “virtual objects”). Depending on the implementation, the device may use the shaded images of the virtual objects for different purposes, such as providing for a user interface, rendering graphics in a video game, generating augmented reality (AR) images, etc. With the proper shadings, the rendered, virtual objects may appear more realistic and/or aesthetically pleasing.

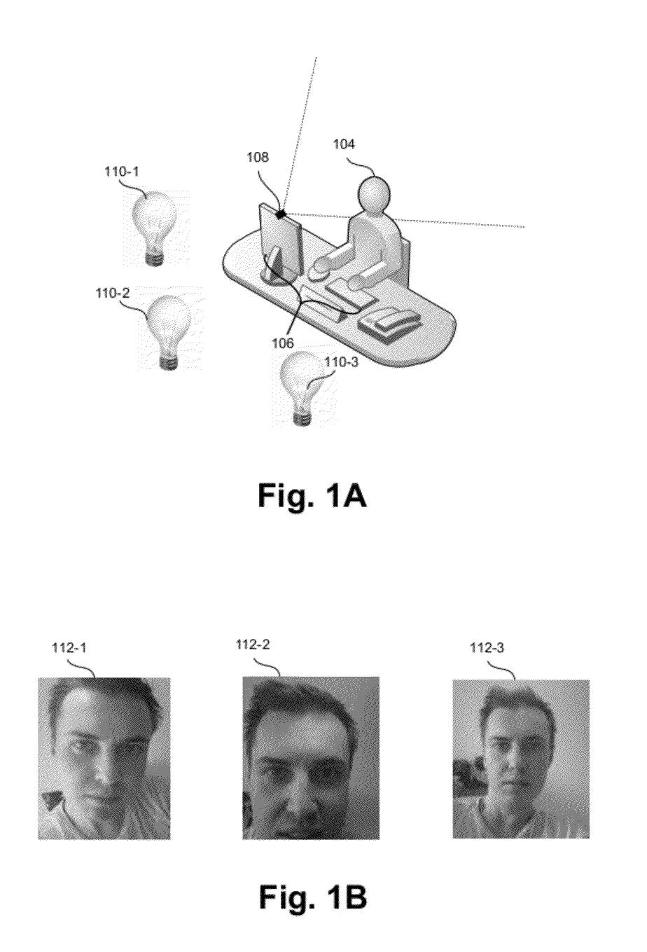

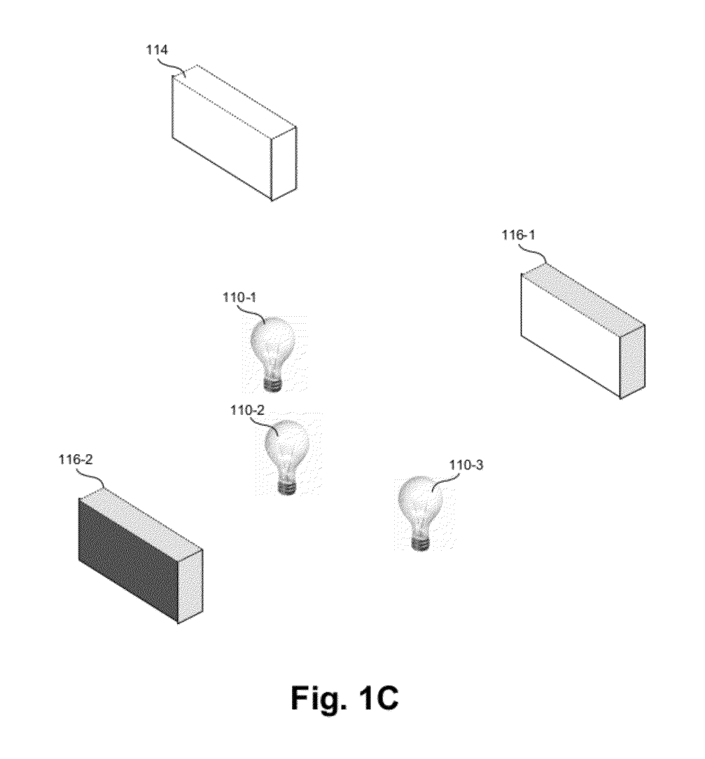

FIGS. 1A through 1C illustrate concepts described herein. Assume that Ola 104 is interacting with a graphics device 106. Graphics device 106 may receive images from a video camera 108 included in graphics device 106. Video camera 108 may capture images of Ola 104's face and may send the captured images to one or more components of graphics device 106. For example, video camera 108 may capture, as shown in FIG. 1B, images 112-1, 112-2, and 112-3. Graphics device 106 may perform face recognition to extract face images and construct a three-dimensional model of the face, for example, via a software program, script, an application such as Polar Rose, etc.

In constructing the three-dimensional model, graphics device 106 may also determine the directions and magnitudes of light rays that would have generated the shadings on the three-dimensional model or the shadings on faces 112-1 through 112-3. Determining the directions and magnitudes of light rays may be equivalent to determining virtual light sources, such as virtual light sources 110-1 through 110-3 (herein “virtual light sources 110” or “virtual light source 110”), from which the light rays may emanate and would have produced the shadings on faces 112-1 through 112-3. Once virtual light sources 110, or equivalently, the directions and magnitudes of the light rays, are determined, graphics device 106 may use virtual light sources 110 to shade images of three-dimensional objects.

FIG. 1C illustrates shading an object using virtual light sources 110. Assume that, in FIG. 1C, graphics device 106 includes, in its memory, a three dimensional model of a building 114. In addition, assume that graphics device 106 includes an application or an application component (e.g., game, a user interface, etc) that is to depict building 114—in a scene that is to be presented to a viewer. Depending on the scene, graphics device 106 may depict building 114 as building image 116-1 (e.g., a scene behind Ola) or as building image 116-2 (e.g, a scene in front of Ola).

Graphics device 106 may determine the directions and magnitude of light rays that impinge on the surface of virtual building 114 from virtual light sources 110-1 through 110-3 and provide appropriate shadings on their surfaces. For example, as shown in FIG. 1C, graphics device 106 may lightly shade the front face of building 114 to produce building image 116-1, and may darkly shade the front surface of building 114 to generate building image 116-2. The shadings may render virtual building 114, or any other object that is shaded based on the determined virtual light sources, more realistic and aesthetically pleasing than it would be without the shadings.

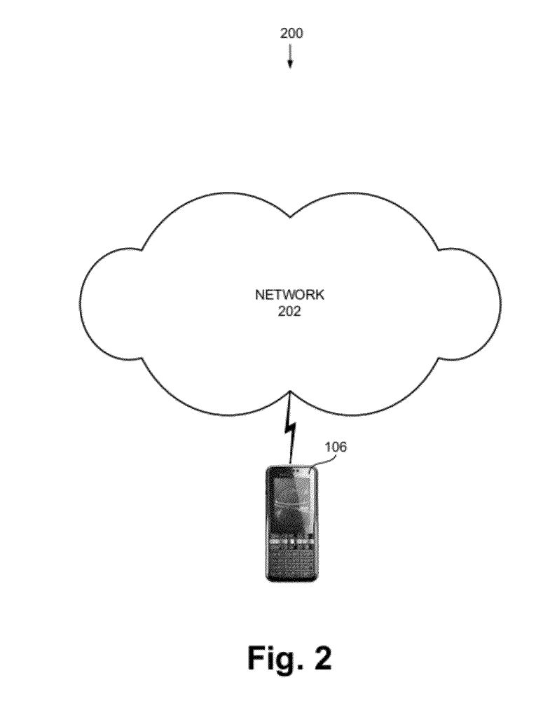

FIG. 2 shows an exemplary system 200 in which the concepts described herein may be implemented. As shown, system 200 may include a graphics device 106 and network 202. In FIG. 2, system 200 is illustrated for simplicity. Although not shown, system 200 may include other types of devices, such as routers, bridges, servers, mobile computers, etc. In addition, depending on the implementation, system 200 may include additional, fewer, or different devices than the ones illustrated in FIG. 2.

Graphics device 106 may include any of the following devices with a display screen: a personal computer; a tablet computer; a smart phone (e.g., cellular or mobile telephone); a laptop computer; a personal communications system (PCS) terminal that may combine a cellular radiotelephone with data processing, facsimile, and/or data communications capabilities; a personal digital assistant (PDA) that can include a telephone; a gaming device or console; a peripheral (e.g., wireless headphone); a digital camera; a display headset (e.g., a pair of augmented reality glasses); or another type of computational or communication device.

In FIG. 2, graphics device 106 may receive images from a camera included on graphics device 106 or from a remote device over network 202. In addition, graphics device 106 may process the received images, generate images of virtual objects, and/or display the virtual objects. In some implementations, graphics device 106 may send the generated images over network 202 to a remote device to be displayed.

Network 202 may include a cellular network, a public switched telephone network (PSTN), a local area network (LAN), a wide area network (WAN), a wireless LAN, a metropolitan area network (MAN), personal area network (PAN), a Long Term Evolution (LTE) network, an intranet, the Internet, a satellite-based network, a fiber-optic network (e.g., passive optical networks (PONs)), an ad hoc network, any other network, or a combination of networks. Devices in system 200 may connect to network 202 via wireless, wired, or optical communication links. Network 202 may allow any of devices 108, 202, and 204 to communicate with one another.

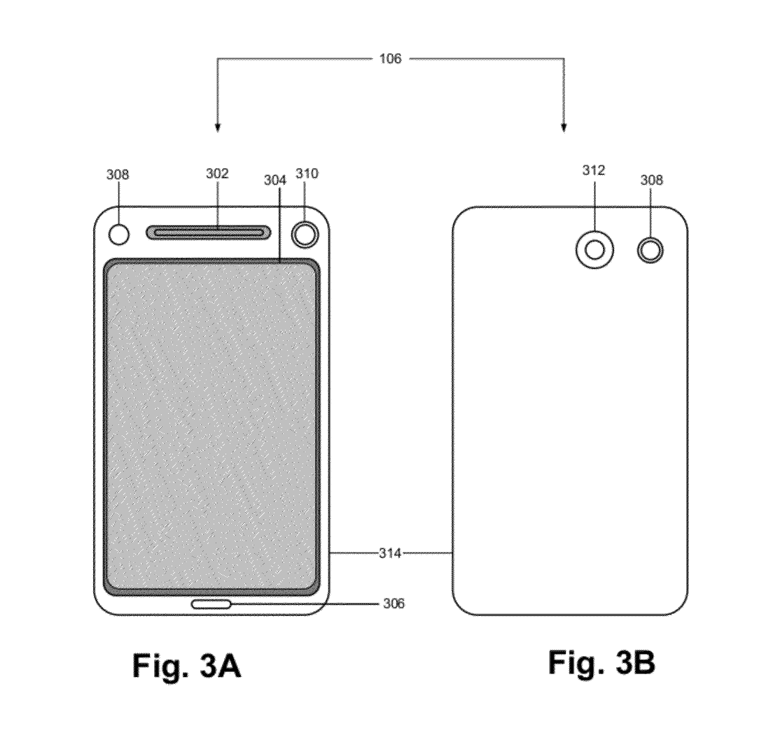

FIGS. 3A and 3B are front and rear views, respectively, of graphics device 106 according to one implementation. In this implementation, graphics device 106 may take the form of a smart phone (e.g., a cellular phone). As shown in FIGS. 3A and 3B, graphics device 106 may include a speaker 302, display 304, microphone 306, sensors 308, front camera 310, rear camera 312, and housing 314. Depending on the implementation, graphics device 106 may include additional, fewer, different, or different arrangement of components than those illustrated in FIGS. 3A and 3B.

Speaker 302 may provide audible information to a user of graphics device 106. Display 304 may provide visual information to the user, such as an image of a caller, video images received via cameras 310/312 or a remote device, etc. In addition, display 304 may include a touch screen via which graphics device 106 receives user input.

Microphone 306 may receive audible information from the user and/or the surroundings. Sensors 308 may collect and provide, e.g., to graphics device 106, information (e.g., acoustic, infrared, etc.) that is used to aid the user in capturing images or to provide other types of information (e.g., a distance between graphics device 106 and a physical object).

Front camera 310 and rear camera 312 may enable a user to view, capture, store, and process images of a subject in/at front/back of graphics device 106. Front camera 310 may be separate from rear camera 312 that is located on the back of graphics device 106. Housing 314 may provide a casing for components of graphics device 106 and may protect the components from outside elements.

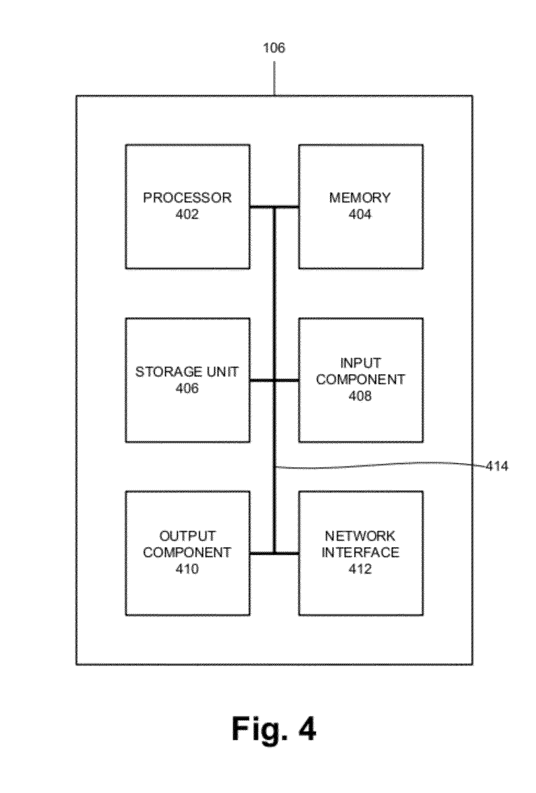

FIG. 4 is a block diagram of exemplary components of a graphics device 106. As shown in FIG. 4, graphics device 106 may include a processor 402, memory 404, storage unit 406, input component 408, output component 410, network interface 412, and communication path 414.

Processor 402 may include a processor, a microprocessor, an Application Specific Integrated Circuit (ASIC), a Field Programmable Gate Array (FPGA), and/or other processing logic (e.g., audio/video processor) capable of processing information and/or controlling graphics device 106.

Memory 404 may include static memory, such as read only memory (ROM), and/or dynamic memory, such as random access memory (RAM), or onboard cache, for storing data and machine-readable instructions. Storage unit 406 may include storage devices, such as a floppy disk, CD ROM, CD read/write (R/W) disc, hard disk drive (HDD), flash memory, as well as other types of storage devices.

Input component 408 and output component 410 may include a display screen, a keyboard, a mouse, a speaker, a microphone, a Digital Video Disk (DVD) writer, a DVD reader, Universal Serial Bus (USB) port, and/or other types of components for converting physical events or phenomena to and/or from digital signals that pertain to graphics device 106.

Network interface 412 may include a transceiver that enables graphics device 106 to communicate with other devices and/or systems. For example, network interface 412 may communicate via a network, such as the Internet, a terrestrial wireless network (e.g., a WLAN), a cellular network, a satellite-based network, a wireless personal area network (WPAN), etc. Network interface 412 may include a modem, an Ethernet interface to a LAN, and/or an interface/connection for connecting graphics device 106 to other devices (e.g., a Bluetooth interface).

Communication path 414 may provide an interface through which components of graphics device 106 can communicate with one another.

In different implementations, graphics device 106 may include additional, fewer, or different components than the ones illustrated in FIG. 4. For example, graphics device 106 may include additional network interfaces, such as interfaces for receiving and sending data packets. In another example, graphics device 106 may include a tactile input device.

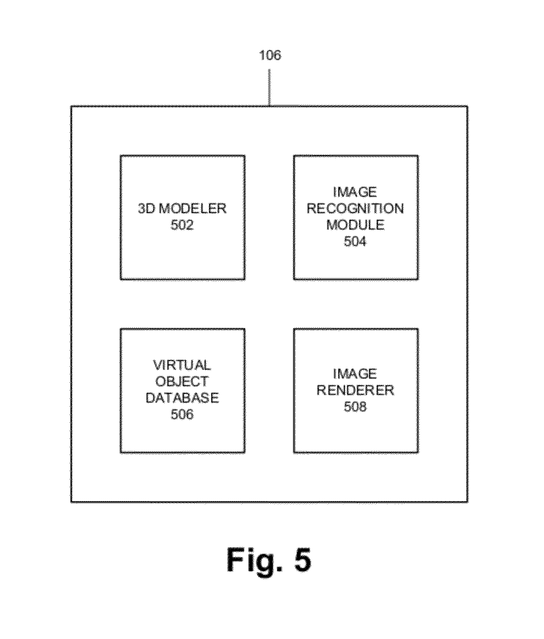

FIG. 5 is a block diagram of exemplary functional components of graphics device 106. As shown, graphics device 106 may include an image recognition module 502, a three-dimensional (3D) modeler 504, a virtual object database 506, and an image renderer 508. All or some of the components illustrated in FIG. 5 may be implemented by processor 402 executing instructions stored in memory 404 of graphics device 106.

Depending on the implementation, graphics device 106 may include additional, fewer, different, or different arrangement of functional components than those illustrated in FIG. 5. For example, graphics device 106 may include an operating system, device drivers, application programming interfaces, etc. In another example, depending on the implementation, components 502, 504, 506, and 508 may be part of a program or an application, such as a game, communication program, augmented-reality program, or another type of application.

Image recognition module 502 may recognize objects in images. For example, image recognition module 502 may recognize one or more faces in images. Image recognition module 502 may pass the recognized images and/or identities of the recognized images to another component, such as, for example, 3D modeler 504.

3D modeler 504 may obtain identities or images of objects that are recognized by image recognition module 502, based on information from virtual object database 506. Furthermore, based on the recognized objects, 3D modeler 504 may infer or obtain parameters that characterize the recognized objects.

For example, 3D modeler 504 may receive images of Ola's face 112-1 through 112-3, and may recognize the face, nose, ears, eyes, pupils, lips, etc. in the received images. Based on the image recognition, 3D modeler 504 may retrieve a 3D model of the face from virtual object database 506. Furthermore, based on the received images, 3D modeler 504 may infer parameters that characterize the 3D model of Ola's face, such as, for example, dimensions/shape of the eyes, the nose, etc.

In addition, 3D modeler 504 may determine surface vectors of the 3D model and identify virtual light sources. Parameters that are related to the surface vectors of the face, related to shades that are shown on the received images, and/or related to the virtual light sources (e.g., locations of pin-point light sources and their luminance) may be solved for or determined in real-time image processing techniques. Once 3D modeler 504 determines the parameters of the recognized 3D object, 3D modeler 504 may provide information that describes the 3D model and the virtual light sources to image renderer 508.

Virtual object database 506 may include images of virtual objects for object recognition, or information for generating, for each of the objects, images or data that can be used for image recognition by image recognition module 502. For example, virtual object database 506 may include data defining a surface of virtual building 114. From the data, image recognition module 502 may extract or derive information that can be used by image recognition module 502.

In addition, virtual object database 506 may include data for generating three-dimensional images of virtual objects. For example, virtual object database 506 may include data that defines surfaces of face. Based on the data and parameters that are determined by 3D modeler 504, image renderer 508 may generate three-dimensional images of the face.

Image renderer 508 may generate images of virtual objects based on images that are received by graphics device 106. For example, assume that graphics device 106 receives images of Ola's face 112-1 through 112-3 via a camera. In addition, assume that graphics device 106 is programmed to provide images of virtual building 114 to Ola or another viewer. In this scenario, image renderer 508 may obtain a 3D model of Ola's face and identify virtual light sources via 3D modeler 504. By using the virtual light sources, image renderer 508 may provide proper shadings for the surfaces of virtual building 114. Image renderer 508 may include or use, for example, the open graphics library (OpenGL) or another graphics application and/or library to render the images.

In some implementations, when image renderer 508 generates the images, image renderer 508 may take into account the location of a display that is to display the image, relative to a camera that captured the images of the viewer's face (e.g., a direction of the display relative to a camera). For example, in FIG. 1C, image renderer 508 may generate different images for displays at different locations in FIG. 1C based on 3D-geometry.

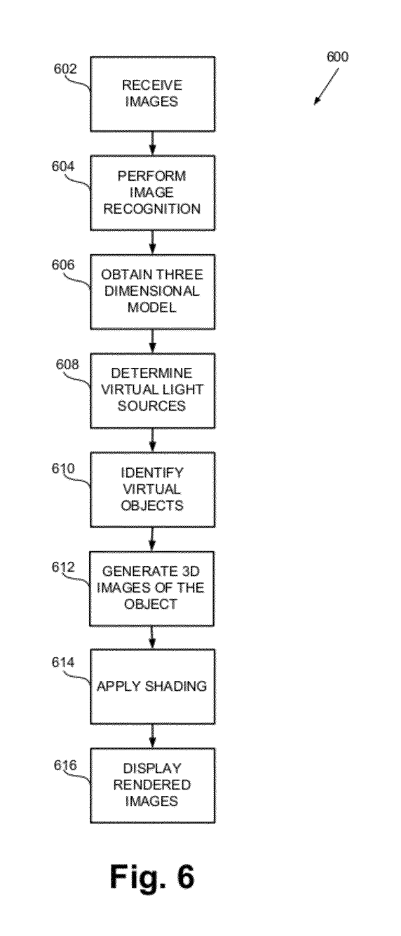

FIG. 6 is a flow diagram of an exemplary process 600 for shading virtual objects based on face images. Process 600 may begin with graphics device 106 receiving images (block 602). Depending on the implementation, graphics device 106 may receive images from cameras 310/312 or a remote device. Graphics device 106 may perform image recognition (block 604). In some implementations, graphics device 106 may perform face recognition.

Graphics device 106 may obtain a 3D model (block 606) of the face or an object recognized at block 604. In obtaining the 3D model, graphics device 106 may also determine virtual light sources (or, equivalently, the direction and magnitude of light rays) that would have produced the shadings on the recognized face/object (block 608). In this process, where possible, graphics device 106 may account for reflecting surfaces, refraction, indirect illumination, and/or caustics to more accurately determine the light sources.

Graphics device 106 may identify virtual objects whose images are to be rendered (block 610). For example, in one implementation, graphics device 106 may identify the virtual objects based on position/location of graphics device 106 (e.g., select a virtual model of a building near graphics device 106). In another example, graphics device 106 that is to depict the viewer in a specific location (e.g., Paris) may select a virtual Eiffel Tower that is to be displayed with images of the viewer. In yet another example, graphics device 106 that is to provide medical information to a surgeon during surgery may identify a virtual object that depicts the organ the surgeon will operate on.

Graphics device 106 may generate 3D images of the identified virtual objects (block 612). In generating the 3D images, by using the virtual light sources, graphics device 106 may apply proper shadings to the 3D images (block 614). In addition, depending on the implementation, graphics device 106 may apply other image processing techniques, such as adding motion blur, texture mappings, non-photorealistic renderings (to save computational time), etc. In some implementations, graphics device 106 may insert the 3D images within other images, in effect “combining” the 3D images with the other images. Alternatively, graphics device 106 may generate the 3D images as stand-alone images. In some implementations, graphics device 106 may generate separate set of images for the right eye and the left eye of the viewer.

Graphics device 106 may display the rendered images (block 616). In a different implementation, graphics device 106 may send the rendered images to a remote device with a display. The remote device may display the images.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

For example, in the above, device 106 may identify/determine virtual light sources based on a 3D model of a face. In other implementations, device 106 may determine/identify light sources that based on a 3D model not of a face, but another type of object (e.g., a vase, bookshelf, computer, etc.) that graphics device 106 may recognize.

In the above, while series of blocks have been described with regard to the exemplary process, the order of the blocks may be modified in other implementations. In addition, non-dependent blocks may represent acts that can be performed in parallel to other blocks. Further, depending on the implementation of functional components, some of the blocks may be omitted from one or more processes.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
receiving, by a graphics device, a plurality of images from a camera;
recognizing, in each of the images, an image of a face;
generating an image of a virtual object and shading the image of the virtual object based on the images of the face; and
displaying the generated image of the virtual object on a first display screen.

2. The method of claim 1, wherein generating the image includes:
applying texture mapping or adding motion blur to the image.

3. The method of claim 1, wherein the images of the face include shadings, and wherein generating the image of the virtual object includes:
using the images of the face to determine directions and magnitudes of light rays that would have produced the shadings on the images of the face; and
using the determined directions and magnitudes of the light rays to create shadings on the image of the virtual object.

4. The method of claim 3, wherein using the images of the face includes:
generating a three-dimensional model of the face.

5. The method of claim 1, wherein generating the image of a virtual object includes providing non-photorealistic rendering of the virtual object.

6. The method of claim 1, wherein generating an image includes generating the image by at least one of:
a gaming application, an augmented reality (AR) device, or a graphical user interface.

7. The method of claim 1, wherein receiving the plurality of images includes:
receiving the plurality of images from a remote device that includes the camera.

8. The method of claim 1, wherein generating the image includes:
generating two different images of the virtual object for two different displays that are located in different places.

9. The method of claim 1, wherein displaying the generated image includes:
sending the generated image to a remote device to be displayed.

10. The method of claim 1, wherein generating the image include:
generating separate images for right and left eyes.

11. A device comprising:
a transceiver for communicating with another device;
a memory to store images; and
a processor to:
recognize, in each of a plurality of images, an image of a face;
shade an image of a virtual object based on the images of the face; and
store the shaded image in the memory.

12. The device of claim 11, wherein the processor is further configured to:
determine virtual light sources based on the images of the face.

13. The device of claim 11, wherein the processor is further configured to:
obtain a three-dimensional model of the face.

14. The device of claim 11, wherein the device includes:
a tablet computer; a smart phone; a laptop computer; a personal digital assistant; or a personal computer.

15. The device of claim 11, wherein the transceiver is configured to receive the plurality of images from a remote device or the processor is configured to receive the plurality of images from a camera installed on the device.

16. The device of claim 11, further comprising a display screen, wherein the processor is configured to display the shaded image on the display screen or send the shaded image to a remote device to be displayed.

17. The device of claim 11, wherein the shaded image of the virtual object includes the image of the face.

18. A computer-readable storage unit, including a program for causing one or more processors to:
receive a plurality of images from a camera;
recognize, in each of the images, an image of a first object;
determine a three-dimensional model of the first object and virtual light sources based on the recognized images of the first object;
generate images of virtual objects and shade the images of the virtual objects based on the virtual light sources; and
display the generated images of the virtual objects on one or more display screens.

19. The computer-readable storage unit of claim 18, wherein the program includes at least one of:
an augmented-reality program; a user interface program; or a video game.

20. The computer readable storage unit of claim 18, further comprising instructions for:
applying texture mapping or motion blur to the generated images of the virtual objects.
